(19) United States
(12) Patent Application Publication
(10) Pub. No.: US 2009/0293696 A1
(43) Pub. Date: Dec. 3, 2009

(54) Cutting Wheel with Disposable Blade

(75) Inventors: Paul D. Rauscher, DePere, WI (US); Bryan Baumgartner, DePere, WI (US)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: EMT INTERNATIONAL, INC., Green Bay, WI (US)

(21) Appl. No.: 12/473,677

(22) Filed: May 28, 2009

Related U.S. Application Data
(60) Provisional application No. 61/056,711, filed on May 28, 2008.

(51) Int. Cl. B26D 1/14

(52) U.S. Cl. 83/665; 83/676; 83/698.41; 30/350

(57) ABSTRACT

A cutting wheel having a disposable blade is a constructed of a disposable blade wheel, an inner support wheel and an outer support wheel to define a three part cutting assembly. An interior hub adapted to be mounted to the three part cutting assembly to provide a cutting wheel assembly. The disposable blade wheel is adapted to be connected to the inner support wheel and the outer support wheel, and may be located between the inner support wheel and outer support wheel. In the three part cutting assembly, an outer periphery of the blade wheel extends radially outwardly of an outer periphery of the inner support wheel and of an outer periphery of the outer support wheel to provide a cutting surface having a cutting edge. The cutting edge comprises a cutting material such as hardened tool steel, high carbon steel, non-ferrous alloys or the like. The cutting wheel assembly is adapted to be mounted onto a conventional rotatable shaft of a conventional web processing machine of the types well known in the art to process a web of material.

### CROSS-REFERENCE TO RELATED APPLICATIONS

This application claims priority to Provisional Application Ser. No. 61/056,711, filed on May 28, 2008.

### BACKGROUND AND SUMMARY OF THE INVENTION

In the production of paper, film, foil, laminate, plastic, vinyl, rubber, woven and non-woven products, a continuous web of such material passes through an in-line web processing apparatus and, often, the web of material requires separation into distinct sections. In line web-processing machines are well-known in the art, and often utilize a cutting wheel mounted on a rotational shelf for processing a web of material. The present application is directed to a novel cutting wheel for slitting, cutting or otherwise processing a web of material into a plurality of web portions, and particularly to a cutting wheel incorporating a unique, disposable blade wheel in a cutting wheel assembly.

It is often desired to separate a single, wide source web of material into a plurality of relatively narrow web portions for use. Generally, efficiency dictates that single, wide webs of material are first created, but transportation and distribution requirements often create the need to reduce the size of the web. Accordingly, it is well known to separate a single wide web into portions through slitting, cutting or otherwise processing the web in a lengthwise direction so that the individual portions are separate from the source web.

Conventional cutting wheels are generally provided on an in-line web processing apparatus and are positioned at transverse points across the web. The cutting wheels are often rotatably mounted about a shaft such that the outer periphery of the wheels (i.e., the blade surface) tangentially contacts an outer surface of the source web. Pressure may be supplied by the web processing apparatus to control the slitting or cutting process. As the web passes the cutting wheels, the web is separated by the cutting wheels into separate and distinct web portions.

However, conventional cutting wheels are constructed almost entirely of tool steel making these cutting wheels expensive to manufacture and replace when worn. A disposable, replaceable cutting wheel that is inexpensive to manufacture and replace would, therefore, create further efficiencies in in-line web processing.

In the present application, a novel cutting wheel has a three part assembly including a disposable blade wheel. The three part wheel assembly comprises an inner support wheel; an outer support wheel; and the disposable blade wheel. In one embodiment, the disposable blade wheel is positioned between the inner support wheel and the outer wheel support hub. This three part assembly then is affixed to an interior hub for rotational movement when mounted on a rotatable shaft of a web cutting machine of the type well known in the art. The disposable blade wheel comprises a circular or disc-type structure wherein only the outer periphery of the wheel is constructed of a cutting material. In one embodiment, the cutting material is hardened tool steel, but the outer periphery may be constructed of any other type of material suitable for cutting a web of material. This outer periphery comprises a cutting edge that will contact a web material for cutting, slitting or otherwise processing a web of material. The disposable blade wheel of the present application has approximately ⅙ the amount of expensive cutting material (e.g. tool steel) than traditional cutting wheels. The disposable blade wheel of the present application is, therefore, less expensive to manufacture and takes far less time to produce.

In one embodiment, the three part cutting wheel is assembled using low profile bolts that attach through the outer support wheel and the disposable blade wheel to connect the outer support wheel and the disposable blade wheel to the inner support wheel. In one embodiment, the low profile bolts may be tightened and loosened with a tool, such as an Allen wrench a hexagonal wrench or other tool. In another embodiment, the bolts may be loosened and tightened by hand. Openings in the outer support wheel hub to receive the bolts allow for “twist and lock” connection of the three part cutting wheel, wherein when the bolts are loosened, the outer support wheel may be twisted such that bolts fit through the larger portion of the opening and the outer support wheel may be removed to access the disposable blade wheel. Likewise, the disposable blade wheel includes the same type of openings for easy removal. When the outer support wheel and disposable blade wheel are secured to the inner support wheel, the bolts are twisted for placement in the smaller portion of the opening and then are tightened either by tool or by hand.

Various other objects, features and advantages of the invention will be made apparent from the following description taken together with the drawings.

### BRIEF DESCRIPTION OF THE SEVERAL VIEWS OF THE DRAWINGS

In the drawings:

FIG. 1 is a sectional side view of the cutting wheel of the present application.

FIG. 2 is an exploded view of the various components comprising one embodiment of the cutting wheel of the present application.

FIG. 3 is a front view of the cutting wheel of the present application.

### DETAILED DESCRIPTION OF THE INVENTION

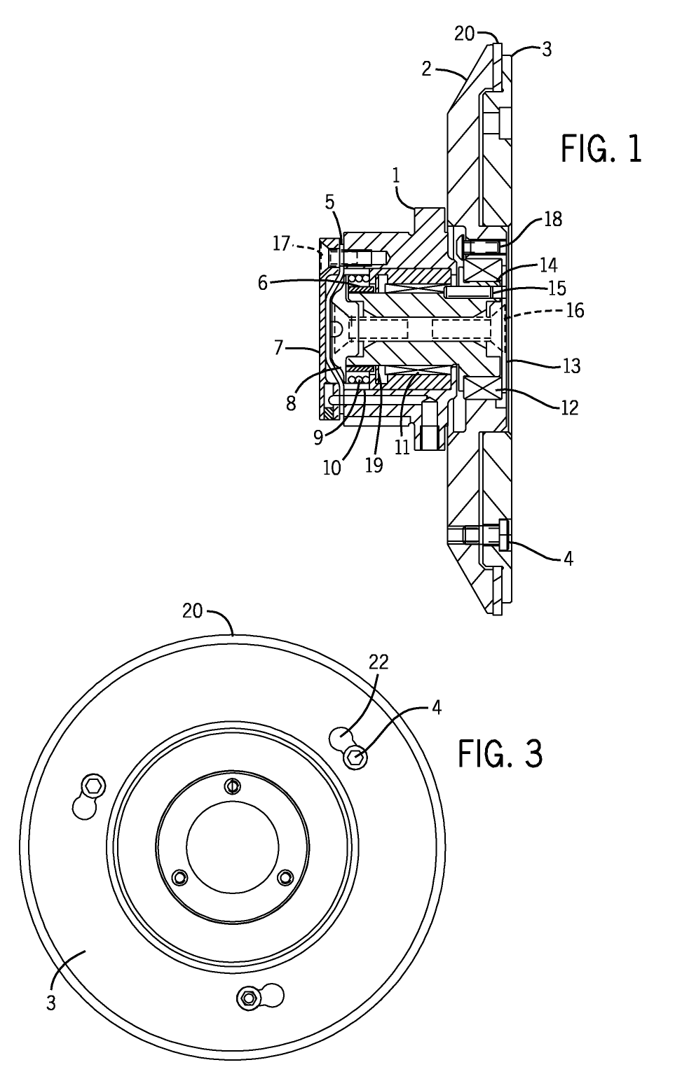

Turning first to FIG. 1, therein is shown a cross section of the cutting wheel assembly of the present application. The cutting wheel assembly includes an interior hub assembly comprising a holder housing 1, a holder axle 14, a piston 8 and at least one bearing 11. In some embodiments, the interior hub assembly further comprises a combination of spacers 6, 10, washers 19; wave springs 9; and diaphragms 5. The interior hub components are typically secured together with a cap 7 using bolts or screws 17, but may be secured in any other conventional manner, as will be recognized by one or ordinary skill in the art. In some embodiments a diaphragm 5 allows for the previously mentioned items to be secured within the holder housing 1. In that embodiment, end cap 7 secured with bolts or screws 17 (or in another conventional manner) secures the diaphragm 5, a piston 8 with rod 16, a wave spring 9, a spacer 6, a nylon washer 19, another spacer 10 and a bearing 11 in holder housing 1. The interior hub allows for the cutting wheel to be positioned and rotatably mounted about a shaft of a web cutting machine of the types well known in the art for tangentially contacting an outer surface of a web of material to process that web of material.

On an outer portion of the cutting wheel assembly, the interior hub assembly connects to a three part cutting assembly comprising an outer support wheel 2, an inner support wheel 3 and a disposable blade wheel 20. The disposable blade wheel 20 is, in one embodiment, positioned in between the outer support wheel 2 and the inner support wheel 3. The three piece cutting assembly is connected using bolts 4 or another conventional connecting means. The inner support wheel 3 and disposable wheel blade 20 include openings 22 for receiving bolts 4 that connect the three part cutting assembly together using, in one embodiment, a “twist and lock” procedure. The “twist and lock” procedure comprises placing the bolts 4 through a larger portion of the openings 22 and loosely securing them to the outer support wheel 2. The inner support wheel 3 and disposable wheel blade 2 are then twisted such that the shafts of the bolt engage a smaller portion of the openings 22. The bolts 4 are then tightened or locked into position securing the three part cutting assembly together. In alternative embodiments, the bolts 4 may be used to directly bolt the three piece cutting assembly together, without using a twist and lock procedure. The bolts 4 may be secured by hand or by using a tool, for example and without limitation, an Allen wrench or hexagonal wrench. FIG. 3 demonstrates the cutting wheel assembly in the secured and locked positions wherein the bolts 4 are secured into portion in the smaller portion of opening 22.

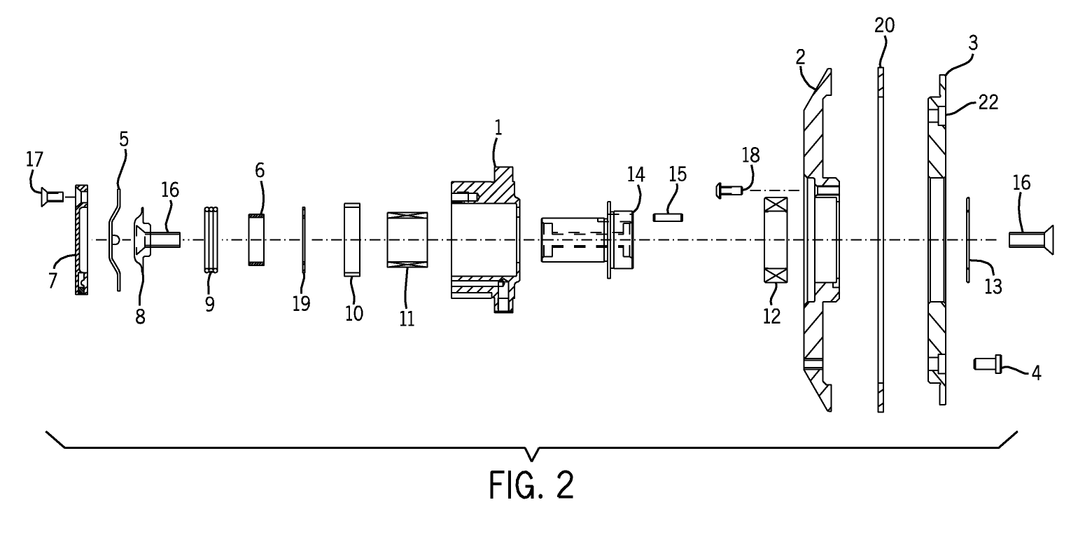

Referring now to FIG. 2, the cutting wheel assembly of one embodiment of the present application will be described. As mentioned, the three part cutting wheel assembly comprising the outer support wheel 2, the disposable blade wheel 20 and the inner support wheel 3 may be secured together with connecting means such as bolts 4 through openings 22. In one embodiment, an end washer 13 further helps secure the three part assembly together using bolts or screws 16. End washer 13 does not engage inner support wheel 3, but instead further connects disposable blade wheel 20 to outer support wheel 2. Outer support wheel 2 may further include a bearing 12 for further assisting in rotational motion of the cutting wheel assembly.

As shown in FIGS. 1 and 2, the interior hub assembly is connected to an outer portion of the outer support wheel 2. When the three part cutting assembly is connected to the interior hub assembly, the cutting wheel may be mounted to a rotational shaft on a conventional web processing machine of the types well known in the art to process a web of material.

The disposable wheel blade 20 comprises an outer periphery constructed of tool grade steel for cutting the web of material. However, the outer periphery may be constructed of other types of material for cutting a web of material such as high carbon steel, high speed steel (HSS), non-ferrous cast alloys, cemented (e.g. sintered) carbides, coated carbides, ceramics, diamonds, or any other type of material suitable for cutting or otherwise processing a web of particular material. The outer periphery may range from less than 0.01 inches to 2.00 inches or greater, depending on the size of the disposable blade wheel 20. However, the amount of material on the outer periphery is not a limiting factor, and a determination may be made for a certain periphery size based on manufacturing economics. The inner portion of the disposable blade wheel 20 may be formed of any material, and in one embodiment, it is constructed of conventional steel. However, the inner periphery of the disposable cutting wheel may be constructed of any material that allows for support of the outer periphery of cutting material defining the cutting edge.

When the blade wheel 20 is assembled together with the inner support wheel 3 and the outer support wheel 2, the outer periphery of the blade wheel 20, protrudes or extends radially outwardly from an outer periphery of the inner support wheel 3 and from an outer periphery of the outer support wheel 2 to further define a cutting edge for the three part cutting wheel assembly.

It is contemplated that when the blade wheel 20 is worn so that it is no longer useful for cutting or otherwise processing a web of material, the connecting means 4 will be loosened and the inner support wheel 3 and disposable wheel 20 be removed from the remainder of the cutting wheel structure. The interior hub may remain connected to the outer support wheel 2. A new wheel blade assembly 20 may then be put into place, the inner support wheel 3 may be placed over the new disposable blade wheel 20 and secured in place using connecting means such as bolts 4, as described above.

It should be further apparent to those skilled in the art that the present invention, as described herein, contains several features and that variations to the preferred embodiment disclosed herein may be made which embody only some of the features disclosed herein. Various other combinations and modifications or alternatives may also be apparent to those skilled in the art. Such variations and alternatives and other embodiments are contemplated as being within the scope of the present application.

What is claimed is:

1. A cutting wheel comprising:
an interior hub;
an inner support wheel;
an outer support wheel; and
a disposable blade wheel having a cutting edge along an outer periphery of the blade wheel, the disposable blade wheel positioned between and adapted to be connected to the inner support wheel and the outer support wheel;
wherein the inner support wheel, outer support wheel and disposable blade wheel, when connected, are further connected to the interior hub for mounting on a rotational shaft for cutting a web of material.

2. The cutting wheel of claim 1, wherein the inner support wheel includes an other periphery and the outer support wheel includes an outer periphery and the outer periphery of the blade wheel extends radially outwardly form the outer periphery of the outer support wheel and the inner support wheel to define a cutting surface.

3. The cutting wheel of claim 1, wherein the cutting edge is selected from the group consisting of hardened tool steel, high carbon steel, high speed steel, non-ferrous cast alloys, cemented carbides, coated carbides, ceramics and diamonds.

4. The cutting wheel of claim 1, wherein the interior hub comprises a holder housing, a holder axle, a piston and at least one bearing.

5. The cutting wheel of claim 1, wherein the outer support wheel further comprises a wheel portion and a bearing portion.

6. The cutting wheel of claim 1, wherein the interior hub is connected to the outer support wheel.

7. The cutting wheel of claim 1, wherein the disposable blade wheel and inner support wheel are connected to the outer support wheel with a plurality of bolts that extend through openings in the blade wheel and inner support wheel and operatively engage the outer support wheel.

8. The cutting wheel of claim 7, wherein the bolts and openings operate to provide a twist and lock connection between the blade wheel, the inner support wheel and the outer support wheel.

9. A cutting wheel comprising:
an interior hub;
a disposable blade wheel having an outer periphery, an inner surface and an outer surface;
an inner support wheel for engaging the inner surface of the blade wheel and having an outer periphery;
an outer support wheel for engaging the outer surface of the blade wheel and having an outer periphery;
the blade wheel being positioned between and connected to the inner support wheel and the outer support wheel such that the outer periphery of the blade wheel extends radially outwardly form the outer periphery of the outer support wheel and the inner support wheel;
the inner support wheel, outer support wheel and disposable blade wheel, when connected, being further connected to the interior hub for mounting on a rotational shaft;
wherein the outer periphery of the disposable blade wheel comprises a cutting edge.

10. The cutting wheel of claim 9, wherein the cutting edge is selected from the group consisting of hardened tool steel, high carbon steel, high speed steel, non-ferrous cast alloys, cemented carbides, coated carbides, ceramics and diamonds.

11. The cutting wheel of claim 9, wherein the interior hub comprises a holder housing, a holder axle, a piston and at least one bearing.

12. The cutting wheel of claim 9, wherein the outer support wheel further comprises a wheel portion and a bearing portion.

13. The cutting wheel of claim 9, wherein the disposable blade wheel and inner support wheel are connected to the outer support wheel with a plurality of bolts that extend through openings in the blade wheel and inner support wheel and operatively engage the outer support wheel.

14. The cutting wheel of claim 13, wherein the bolts and openings operate to provide a twist and lock connection between the blade wheel, the inner support wheel and the outer support wheel.
